(19) United States
(12) Patent Application Publication
(10) Pub. No.: US 2006/0020714 A1
(43) Pub. Date: Jan. 26, 2006

(54) System, apparatus and method of displaying images based on image content

(75) Inventors: Janice Marie Girouard, Austin, TX (US); Dustin C. Kirkland, Austin, TX (US); Emily Jane Ratliff, Austin, TX (US); Kylene Jo Hall, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 10/897,216

(22) Filed: Jul. 22, 2004

(51) Int. Cl. G06F 15/16

(52) U.S. Cl. 709/246; 709/225

(57) ABSTRACT

A system, apparatus and method of displaying images based on image content are provided. To do so, a database of offensive images is maintained. Stored in the database, however, are hashed versions of the offensive images. When a user is accessing a Web page and the Web page contains an image, the image is hashed and the hashed image is compared to hashed images stored in the database. A match between the message digest of the image on the Web page and one of the stored message digests indicates that the image is offensive. All offensive images are precluded from being displayed.

### BACKGROUND OF THE INVENTION

1. Technical Field

The present invention is directed toward Internet content filtering. More specifically, the present invention is directed to a system, apparatus and method of displaying images based on image content.

2. Description of Related Art

Due to the nature of the Internet, anyone may access any Web page available thereon at anytime. A vast number of Web pages, however, contain offensive materials (i.e., materials of a pornographic, sexual and/or violent nature). In some situations, it may be desirable to limit the type of Web pages that certain individuals may access. For example, in particular settings (e.g., educational settings) it may be undesirable for individuals to access Web pages that have offensive materials. In those settings, some sort of filtering mechanism has generally been used to inhibit access to offensive Web pages.

Presently, there is a plurality of filtering software packages available to the public. They include SurfWatch, Cyberpatrol, Cybersitter, NetNanny etc. These filtering software packages may each use a different scheme to filter out offensive Web pages. For example, some may do so based on keywords on the sites (e.g., “sex,” “nude,” “porn,” “erotica,” “death,” “dead,” “bloody,” etc.) while others may do so based on a list of forbidden Web sites to which access should be precluded.

There may be instances, however, where a Web page may contain offensive images without using any one of the offensive keywords or that a Web page with offensive images may be on a Web site that may not have been entered in the list of forbidden Web sites. In those instances, an individual who may have been precluded from accessing offensive Web pages in general may nonetheless access those Web pages.

Thus, what is needed is a system, apparatus and method of displaying images based on image content.

### SUMMARY OF THE INVENTION

The present invention provides a system, apparatus and method of displaying images based on image content are provided. To do so, a database of offensive images is maintained. Stored in the database, however, are hashed versions of the offensive images. When a user is accessing a Web page and the Web page contains an image, the image is hashed and the hashed image is compared to hashed images stored in the database. A match between the message digest of the image on the Web page and one of the stored message digests indicates that the image is offensive. All offensive images are precluded from being displayed.

In a particular embodiment, Web pages are identified as offensive based on image contents. Again, a database of hashed offensive images is maintained. When a Web page that has an image is being accessed, the image is hashed and then compared to the hashed images in the database. If there is a match, the Web page may be classified as offensive. Network addresses of all Web pages that contain offensive images may then be entered into a censored list.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a flowchart of a process that may be used by the present invention.

### DETAILED DESCRIPTION OF THE PREFERRED EMBODIMENT

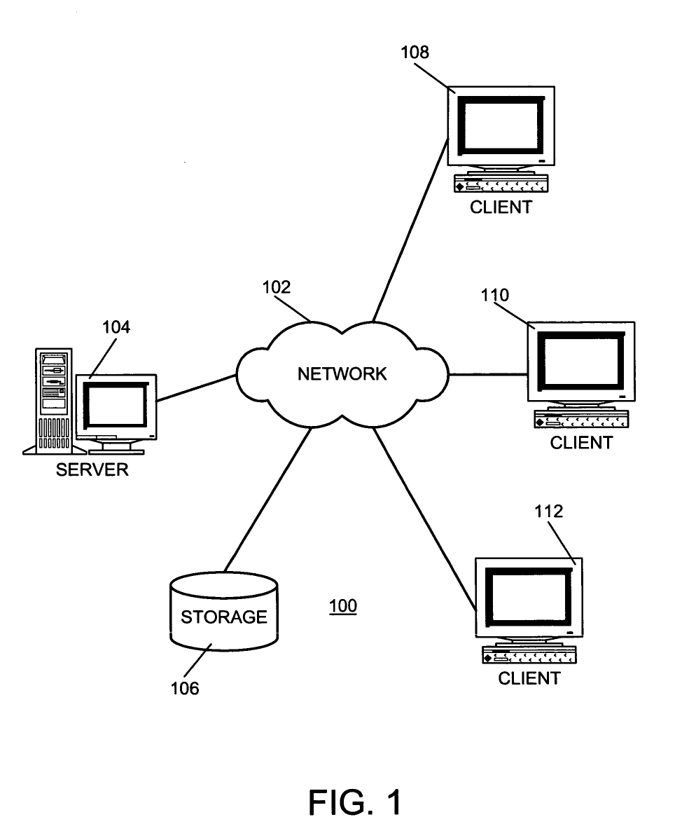

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

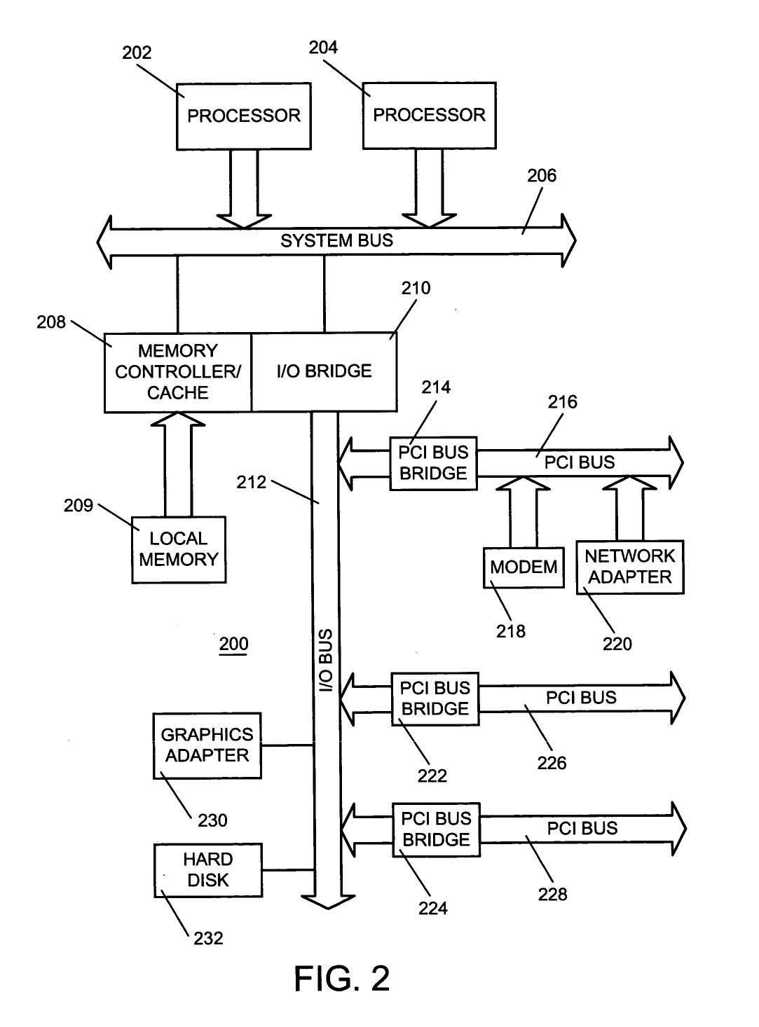

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, N.Y., running the Advanced Interactive Executive (AIX) operating system or LINUX operating system.

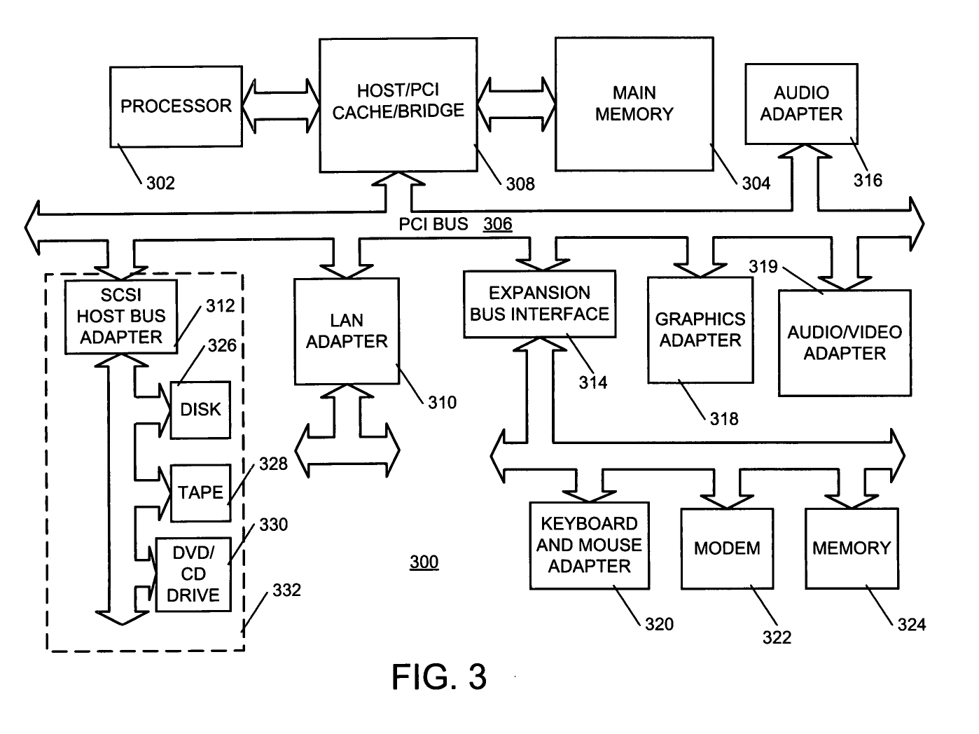

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM/DVD drive 330. Typical PCI local bus implementations will support three or four PCI expansion slots or add-in connectors.

An operating system runs on processor 302 and is used to coordinate and provide control of various components within data processing system 300 in FIG. 3. The operating system may be an open source operating system, such as Linux, which is available from ftp.kernel.org. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, apparatus and method of identifying and filtering out offensive web pages based on image contents. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

MD5 is an established standard and is defined in Requests-For-Comments (RFC) 1321. MD5 is used for digital signature applications where a large message has to be compressed in a secure manner before being signed with a private key. MD5 takes a message (e.g., a binary file) of arbitrary length and produces a 128-bit message digest. A message digest is a compact digital signature for an arbitrarily long stream of binary data. Theoretically, a message digest algorithm may never generate the same signature for two different sets of input. However, achieving such theoretical perfection requires a message digest the length of the input file. As an alternative, practical message digest algorithms compromise in favor of a digital signature of modest size created with an algorithm designed to make preparation of input text with a given signature computationally infeasible. MD5 was developed by Ron Rivest of the MIT Laboratory for Computer Science and RSA Data Security, Inc. Note that RFC is a set of technical and organizational notes about the Internet. Memos in the RFC series discuss many aspects of computer networking, including protocols, procedures, programs and concepts etc.

The present invention computes an MD5 message digest for a known offensive image and stores it in an access monitoring database. This stored message digest may be used to identify and filter out offensive images. To do so however, a user may have to initially identify a Web site that contains Web pages with offensive materials (in this case, the list of offensive Web sites already identified by filtering software packages such as CyberSitter, NetNanny etc. may be used as a starting point). Then, the MD5 message digest of each offensive image in the offensive Web sites may be computed and stored.

When a Web page is being accessed and if the Web page contains an image, the MD5 message digest of the image may be computed. After the MD5 message digest of the image is computed, it is compared to the stored MD5 message digests (i.e., the message digests of the offensive images in the database). If there is a match, then the image is an offensive image.

In some cases, there may also be a database in which MD5 message digests of non-offensive images are kept. In those cases, the computed MD5 message digest of the image in the Web page being accessed may be compared to the stored message digests. If there is a match then the image is a non-offensive image.

In the case where there is not a match between the computed MD5 message digest and a stored message digest (the message digest of either an offensive or a non-offensive image), the message may be labeled as indeterminate. At that point and if the image is the only image on the Web page, it may be sent to a user for classification. However, if there are more than one image on the Web page, (e.g., three images) and if the computed MD5 message digest of two of the images match each a stored MD5 message digest stored in an offensive MD5 message digest database, then as before those two images are offensive. The third image (i.e. the image whose MD5 message digest did not match any stored MD5 message digest) may or may not be offensive.

To determine whether the third image is an offensive image, an offensive probability number may be calculated. Since this calculation may be quite intensive, the elements that may be used to calculate this number may be user-configurable. For example, depending on the amount of processing power a user may want to utilize to determine whether the image is offensive, all, a few or one of the following elements may be used to calculate the number: (1) relative proximity of the image to a known offensive or non-offensive image on the Web page; (2) the size of the image in question (non-offensive images such as credit card icons are often small images); (3) a byte comparison to similar images to determine differences between the images etc.

To arrive at the offensive probability number, a weight may be given to each one of the elements. The weights may then be added together to form the offensive probability number. For example, if the image is surrounded by and is in close proximity to images whose MD5 message digests match with MD5 message digests of known offensive images then on a scale of 1-10, a weight of 8 or 9 may be attributed to this part of the calculation. If the image is a relatively large image (e.g., close to the size or larger than offensive images on the Web page), a weight of between 5 and 9 may be attributed to this calculation. Further, if from the byte comparison, it appears that the image varies little from an offensive image, then a weight of 8 or 9 may be given to this calculation.

Thus, the offensive probability number may be between 21 and 27 (i.e., an average number between 7 and 9). If it is established that an offensive probability number greater than a threshold of 6 indicates an offensive image, then the image may be classified as an offensive image. If the offensive probability number is less than but close to the threshold, then the image may be categorized as indeterminate. As mentioned above, indeterminate images may be sent to a user for classification. If the offensive probability number is a low number (e.g., 1 or 2) then the image may be classified as a non-offensive image.

The MD5 message digest of any image that is classified as an offensive image may be entered into the database where MD5 message digests of offensive images are kept. Likewise, if a database for MD5 message digest of non-offensive images is used, then the MD5 message digest of an image that has been classified as a non-offensive image may be entered in that database. Note that entering MD5 message digests of offensive and/or non-offensive images in their respective database may yield a higher future offensive/non-offensive image classification accuracy. Note further that the Web sites and/or Web pages containing images that have been classified as offensive may be added to the list of offensive Web sites that software companies such as NetNanny, CyberSitter etc. use.

Each stored message digest of an image may have associated therewith a rating. The rating may be used to determine who may access the image. For example, if a parent of a child specifies that the child may not view images having a rating of 6 or higher, then no images having a 6 or higher rating will display when the child is using the system (so long as the child is logged on the system as himself or herself). Therefore, if the child is accessing a Web page having an image whose message digest matches the message digest of a stored image with a rating of 6, the image will not display. In the case where the message digest of the image does not match any of the stored message digests, a probabilistic rating may be computed. To do so, a similar algorithm as the one used to compute the offensive probability number may be used.

Hence, offensive probability numbers are also probabilistic ratings. If, however, a user (i.e., an administrator) assigns a rating to an image, then the rating is a deterministic rating. Probabilistic ratings become deterministic once confirmed by a user.

The invention was described using MD5 as a hash algorithm. However, it should be noted that the invention is not thus restricted. Any other hash algorithm may be used. Specifically, any algorithm that makes it computationally infeasible for two different messages to have the same message digest may be used. For example, Secure Hash Algorithm (SHA), SHA-1, MD2, MDC2, RMD-160 etc. may equally be used. Thus, MD5 was used for illustrative purposes only.

The invention may be implemented on an ISP's server, on a local client machine (i.e., a user's computer system) or on a transparent proxy server such as Squid. (Squid is a full-featured Web proxy cache designed to run on Unix systems.) In the case where the invention is implemented on a local client machine, a head of a household may instantiate the invention to ensure that under-aged children are not exposed to offensive images on the Internet.

Further, the invention may be implemented on a mail server or mail client to provide an offensive spam filtering technique. Specifically, offensive images from e-mail messages may be filtered out of in-boxes on computer systems on which the invention is implemented.

To summarize, the invention may be implemented at a service's main server or on a user's local client from within a browser. It may also be implemented in a transparent proxy server (e.g., squid) that may be implemented by a head of household, corporation or Internet Service Provider (ISP). This technique also provides an effective offensive spam filtering technique that may be implemented by a mail server or mail client by stripping offensive graphics from in-boxes.

When implemented on a server, a database of offensive images and their MD5 values may be generated initially from a set of images known to be offensive. These database elements may be expanded manually by user identification or automatically by the tool. For the automatic case, a google-like tool may cache the MD5 sums of images on known offensive sites, then may cross-reference these MD5 values with those found on alternate sites. This google-like tool would use techniques in use today for managing lists of Web pages (i.e., URLs) and topics for searching, for example, caching the URLs and their MD5 sums in advance of a user's request. The difference form today's tools would be the MD5 sums would be used to identify the search topic in lieu of text.

When an offensive quotient at this new site is calculated and found to exceed a value, the new site is added to the list of offensive URLs that are banned and the MD5 values of the images shown on this new URL are added to the offensive database. This process is repeated until no new Web pages that exceed the offensiveness threshold are identified. As a user manually identifies offensive images, this automatic process is triggered to extend the offensive database beyond the identified URL/images.

When a browser attempts to recall an offensive Web page, or a caching scheme is employed to retrieve an image from its local database, the delivery of the graphic image or the Web page is terminated with a message to the user indicating that the material is not available due to its offensive nature.

When implemented at the client browser level, the entire database build/extension function may occur on the client's local host making use of spare cycles as a background task. One approach would be to assume that the material is acceptable until an image is flagged in the local database as offensive. Further, the offensive database may be extended when system activity is low. Updating the database may work much like automatically updating anti-virus software. The client may periodically update its database of MD5 hashes that represent offensive material. In this way, clients wishing to avoid offensive material do not actually need to store the graphical images in their database, but only hashes of the images.

Hence, the invention provides a method and apparatus for maintaining a central (or local) database of images where the images are stored as a hash as well as an offensive rating. Using this database, clients can automatically filter their content by indexing each image's hash on a loading Web page against this central database. When a match is found, the offensiveness rating is returned to the client and based on the client's configuration options, it can optionally choose to display some, none or all of the material.

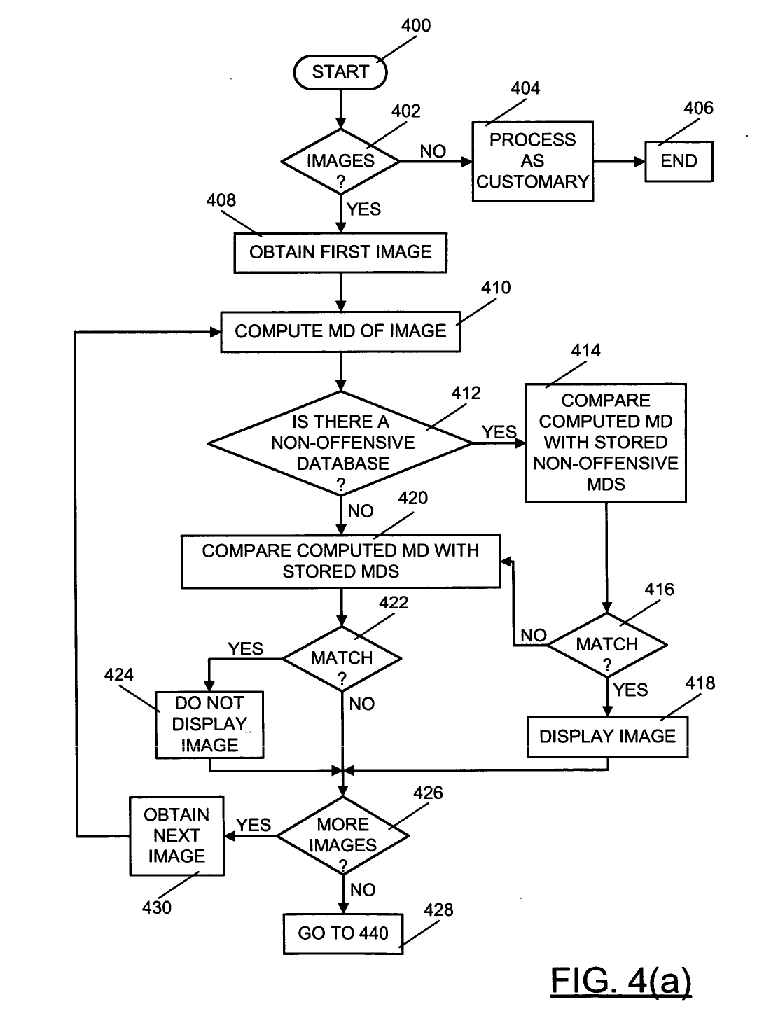

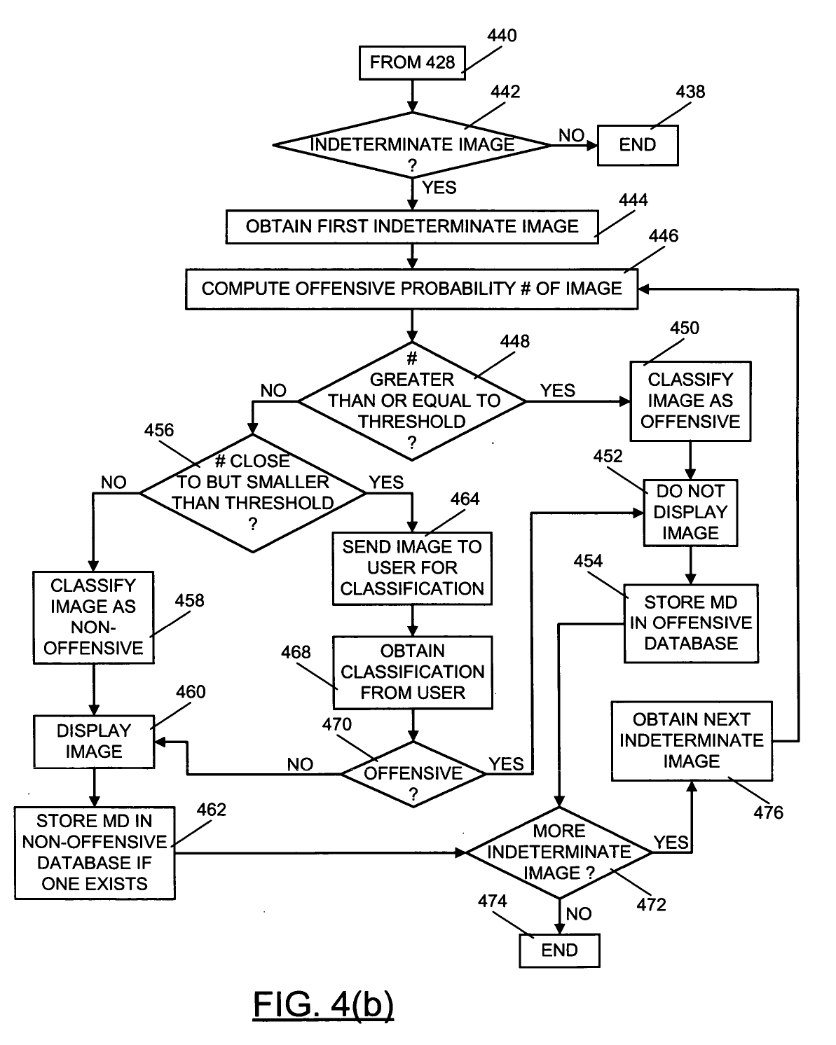

FIG. 4 is a flowchart of a process that may be used to implement the invention. The process starts when a Web page is being accessed (step 400). At that point, a check is made to determine whether there are any images on the Web page. If not, the Web page is processed as customary before the process ends (steps 404 and 406). If there are images on the Web page, the binary file of a first image is hashed to obtain a message digest (steps 402, 407 and 410). Once done and if there is a non-offensive database, the message digest is then compared to stored message digests in the non-offensive database. If there is a match then the image may be displayed. The display of the image will of course be based on the rating. That is, if the system is configured to display images having the rating of the image with a particular user, then the image will be displayed (steps 412, 414, 416 and 418). If there is not a non-offensive database, then the computed message digest is compared to message digests in the offensive database. The image will not be displayed if there is a match with any of the stored message digests. Here again, if the system is configured to display images with such a rating to a particular individual, the image will be displayed (steps 412, 420, 422 and 424).

If there is not a match with either message digests stored in the non-offensive database or the offensive database, a check will be made to determine if there is another image on the Web page to process. If there is another image, the binary file of the image will be obtained and the process will jump back to step 410 (steps 426, 430 and 410). If there is not another image, the process will jump to step 440).

Once at step 440, a check will be made to determine whether any of the images on the Web page was classified as indeterminate. Note that any image for which there was not a match with a message digest in either the offensive or non-offensive database is an indeterminate image. If there is not an indeterminate image, the process may end (steps 440, 442 and 438). If there is at least one indeterminate image, then an offensive probability number will be calculated for that image (steps 442, 444 and 446). If the calculated number is greater than or equal to a user-defined threshold number, the image may be classified as offensive. If the image is classified as offensive, it will not be displayed and its message digest may be entered in the offensive database. In the case where images with such a rating should be displayed to an individual, the image will be displayed if the individual is the one using the system (steps 448, 450, 452 and 454).

If the calculated offensive probability number is significantly less than the user-defined threshold number, it may be classified as non-offensive. As mentioned above, non-offensive images are displayed (based of course on its rating and a particular user) and their message digests stored in the non-offensive database, if one exists (steps 456, 458, 460 and 462). If the offensive probability number calculated is close to but less than the threshold number the image may then be sent to a user for classification. If the user classified the image as offensive, the process will jump back to step 452. If instead the user classifies the image as non-offensive, the process will jump back to step 460.

After the message digest of a previously indeterminate image is stored in either of the offensive or the non-offensive database, a check may be made to determine whether there is another indeterminate image to process (steps 474 and 476). If there is another indeterminate image, the process jumps back to step 446. If not, the process ends (steps 472 and 474).

As mentioned before, Web pages or Web sites having images that have been classified as offensive may be added to lists of Web pages or sites used for censoring Web user accesses.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of displaying images on Web pages comprising the steps of:
maintaining a database of hashed offensive images;
comparing a hashed version of an image on a Web page being displayed with the hashed images stored in the database; and
displaying the image on the Web page if there is not a match between the hashed version of the image and one of the hashed images stored in the database.

2. The method of claim 1 wherein each stored hashed image has a rating associated therewith, the rating for allowing an image whose hashed version matches a stored hashed image to display based on user-configuration.

3. The method of claim 1 wherein before the image is displayed, an offensive probability number is computed, the offensive probability number for allowing the image to be displayed if it is less than a threshold number.

4. The method of claim 3 wherein if the offensive probability number is equal to or greater than the threshold number, the image is classified as offensive.

5. A method of identifying offensive Web pages based on image contents comprising the steps of:
maintaining a database of hashed offensive images;
comparing a hashed version of an image on a Web page to the hashed images stored in the database; and
identifying the Web page as offensive if there is a match between the hashed version of the image and one of the hashed images stored in the database.

6. A computer program product on a computer readable medium for displaying images on Web pages comprising:
code means for maintaining a database of hashed offensive images;
code means for comparing a hashed version of an image on a Web page being displayed with the hashed images stored in the database; and
code means for displaying the image on the Web page if there is not a match between the hashed version of the image and one of the hashed images stored in the database.

7. The computer program product of claim 6 wherein each stored hashed image has a rating associated therewith, the rating for allowing an image whose hashed version matches a stored hashed image to display based on user-configuration.

8. The computer program product of claim 6 wherein before the image is displayed, an offensive probability number is computed, the offensive probability number for allowing the image to be displayed if it is less than a threshold number.

9. The computer program product of claim 7 wherein if the offensive probability number is equal to or greater than the threshold number, the image is classified as offensive.

10. A computer program product on a computer readable medium for identifying offensive Web pages based on image contents comprising:
code means for maintaining a database of hashed offensive images;
code means for comparing a hashed version of an image on a Web page to the hashed images stored in the database; and
code means for identifying the Web page as offensive if there is a match between the hashed version of the image and one of the hashed images stored in the database.

11. An apparatus for displaying images on Web pages comprising:
means for maintaining a database of hashed offensive images;
means for comparing a hashed version of an image on a Web page being displayed with the hashed images stored in the database; and
means for displaying the image on the Web page if there is not a match between the hashed version of the image and one of the hashed images stored in the database.

12. The apparatus of claim 11 wherein each stored hashed image has a rating associated therewith, the rating for allowing an image whose hashed version matches a stored hashed image to display based on user-configuration.

13. The apparatus of claim 11 wherein before the image is displayed, an offensive probability number is computed, the offensive probability number for allowing the image to be displayed if it is less than a threshold number.

14. The apparatus of claim 13 wherein if the offensive probability number is equal to or greater than the threshold number, the image is classified as offensive.

15. An apparatus for identifying offensive Web pages based on image contents comprising:
means for maintaining a database of hashed offensive images;
means for comparing a hashed version of an image on a Web page to the hashed images stored in the database; and
means for identifying the Web page as offensive if there is a match between the hashed version of the image and one of the hashed images stored in the database.

16. A system for displaying images on Web pages comprising:
at least one storage device for storing code data; and
at least one processor for processing the code data to maintain a database of hashed offensive images, to compare a hashed version of an image on a Web page being displayed with the hashed images stored in the database, and to display the image on the Web page if there is not a match between the hashed version of the image and one of the hashed images stored in the database.

17. The system of claim 16 wherein each stored hashed image has a rating associated therewith, the rating for allowing an image whose hashed version matches a stored hashed image to display based on user-configuration.

18. The system of claim 16 wherein before the image is displayed, an offensive probability number is computed, the offensive probability number for allowing the image to be displayed if it is less than a threshold number.

19. The system of claim 18 wherein if the offensive probability number is equal to or greater than the threshold number, the image is classified as offensive.

20. A system for identifying offensive Web pages based on image contents comprising:
at least one storage device for storing code data; and
at least one processor for processing the code data to maintain a database of hashed offensive images, to compare a hashed version of an image on a Web page to the hashed images stored in the database, and to identify the Web page as offensive if there is a match between the hashed version of the image and one of the hashed images stored in the database.
